(19) United States
(12) Patent Application Publication
(10) Pub. No.: US 2016/0274685 A1
(43) Pub. Date: Sep. 22, 2016

(54) COMPANION INPUT DEVICE

(71) Applicant: ADOBE SYSTEMS INCORPORATED, San Jose, CA (US)

(72) Inventor: GEOFFREY CHARLES DOWD, SAN FRANCISCO, CA (US)

(21) Appl. No.: 14/663,079

(22) Filed: Mar. 19, 2015

(51) Int. Cl. G06F 3/0354; G06F 3/02

(52) U.S. Cl. CPC G06F 3/03547; G06F 3/0227; G06F 3/0202

(57) ABSTRACT

An input device for providing inputs to a computing device includes an enclosure having a top, a bottom, and at least three sides such that the top and bottom have a polygonal shape. The top includes a trackpad substantially centered on the top surrounded by buttons at the corners of the top. In particular, a button is provided at each corner on the top of the device. The trackpad provides for touch input while the buttons may be mapped to shortcut keys for providing input to a paired computing device.

### BACKGROUND

Creative professionals have learned to rely heavily on a combination of physical inputs in order to create works with speed, efficiency, control, and precision. On a desktop or laptop computer, keyboard keys, commands, and shortcuts serve this need. However, this level of control is noticeably lacking on touchscreen devices. While it is very intuitive for a user to draw on a touchscreen using a finger, there is a lack of precision. Additionally, the user's finger often occludes what is being displayed on the screen. Some pen-link or stylus devices, such as the ADOBE INK device, have been developed for producing writings or drawings on a touchscreen with much more precision than just using a finger. Additionally, such pen-like devices often include a number of secondary functionalities (e.g., wireless communication, storage, additional, user inputs, enabling/disabling features, visual or haptic feedback, etc.) that may facilitate creative work. Despite improvements in touchscreen technologies and the availability of pen-like devices useable with touchscreens, creative professionals remain reluctant to do a significant amount of professional work on touchscreen devices.

One reason for this reluctance is that touchscreen devices typically do not include any hardware keyboard. As a result, shortcut keys, such as the “shift,” “ctrl,” “cmd,” “alt,” and “fn” keys that are frequently used by creative professionals to increase the speed and efficiency of their work are not available. While a soft keyboard may be presented on a touchscreen, the keyboard takes up a significant amount of the screen space, reducing the viewable area of the workspace. Additionally, while hardware keyboards are available that may be paired with touchscreen devices, creative professionals typically don't need full-fledge keyboards to perform their work and are reluctant to carry around a bulky keyboard with touchscreen devices. Moreover, such hardware keyboards are not ideal for use in mobile situations such as sitting on a couch or on a bus.

### SUMMARY

Embodiments of the present invention relate to an input device that may be paired with a computing device, such as a touchscreen, to allow a user to quickly and efficiently provide inputs to applications running on the paired computing device. The input device includes a top having a polygonal shape with a trackpad substantially centered on the top surrounded by buttons at the corners. In particular, a single button is provided at each corner on the top of the input device. The trackpad provides touch inputs to applications running on a paired computing device while the buttons may be mapped to shortcut keys, which may be keyboard keys such as the “shift,” “ctrl,” “cmd,” “alt,” and “fn” keys. As such, the input device provides inputs frequently used by creative professionals but often not available when using touchscreen devices. The input device is intentionally minimalist in design to allow a user to quickly and blindly interact with the input device, thereby enhancing speed, efficiency, control, and precision in their work.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a top perspective view of an input device;

FIG. 2 is a plan view of the top of the input device;

FIG. 3 is a side elevation view of the input device;

FIG. 4 is a plan view of the bottom of the input device;

FIG. 5 is a top perspective view of a charger case containing an input device;

FIG. 6 is a top perspective view of the charger case without the input device;

FIG. 7 is a bottom perspective view of the charger case;

FIG. 8 is a bottom perspective view of the charger case with a charging arm extended;

FIG. 9 is a top perspective view of an input device in accordance with another configuration; and

FIG. 10 is a system diagram showing an input device paired with a touchscreen device and digital pen.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different elements or combinations of elements similar to the ones described in this document, in conjunction with other present or future technologies.

Embodiments of the present invention are generally directed to an input device that solves the problem of bringing speed, efficiency, control, and precision to touchscreen devices. The input device has a polygon-shaped top surface that includes a trackpad surrounded by a button at each corner. For instance, in one configuration, the input device has a triangular-shaped top surface having three corners with a trackpad substantially centered on the top surface and three buttons located at the three corners. The trackpad provides for multi-touch and gesture input that may be mapped to a variety of input features of applications. The buttons may be mapped to shortcut keys, which may be keyboard keys, such as the “shift,” “ctrl,” “cmd,” “alt,” and “fn” keys. In some embodiments, buttons are only provided on the corners of the top surface to simplify the design. In particular, by limiting the inputs included on the input device to the trackpad and buttons at each corner, the design of the input device is simplified and users may access frequently used inputs very quickly without taking their eyes from their work displayed on the screen. Additionally, the minimalist design helps reduce the size of the input device and thereby increases portability for mobile use. The location of the buttons at each of the corners on the top surface of the input device further increases speed and efficiency as users may blindly find each corner by feel without having to look at the input device. Further, the device may be sized

As such, the input device allows variety of input scenarios. For instance, the input device may be used to constrain the angle of movement of a selected object. Duplicate and array, and create iteration may be achieved with a circular scroll motion in the trackpad. Accordingly, with increased speed, interactions on a touch screen that were previously impossible are enabled using the input device.

While this description primarily discusses the use of the input device with a touchscreen device, it should be understood that the input device may be paired with any computing device. Although devices such as desktop and laptop computers have dedicated keyboards, the simplistic design of the input device may allow for improved speed and efficiency by providing quick access to frequently used inputs.

With reference to the drawings, wherein like reference characters designate like parts throughout the different views, an input device according to an embodiment of the present invention is designated generally with the reference numeral 10. The input device 10 includes an enclosure 12 that generally includes a top 14, a bottom 16, and three sides 18, 20, 22. The enclosure 12 may generally be an integrated unit constructed from metal, molded plastic, or any other suitable material. The enclosure 12 is configured to define a container, which houses internal electronic components (not shown), such as, for instance a power source, processor, computer storage media, and a wireless communication module (e.g., a Bluetooth transceiver).

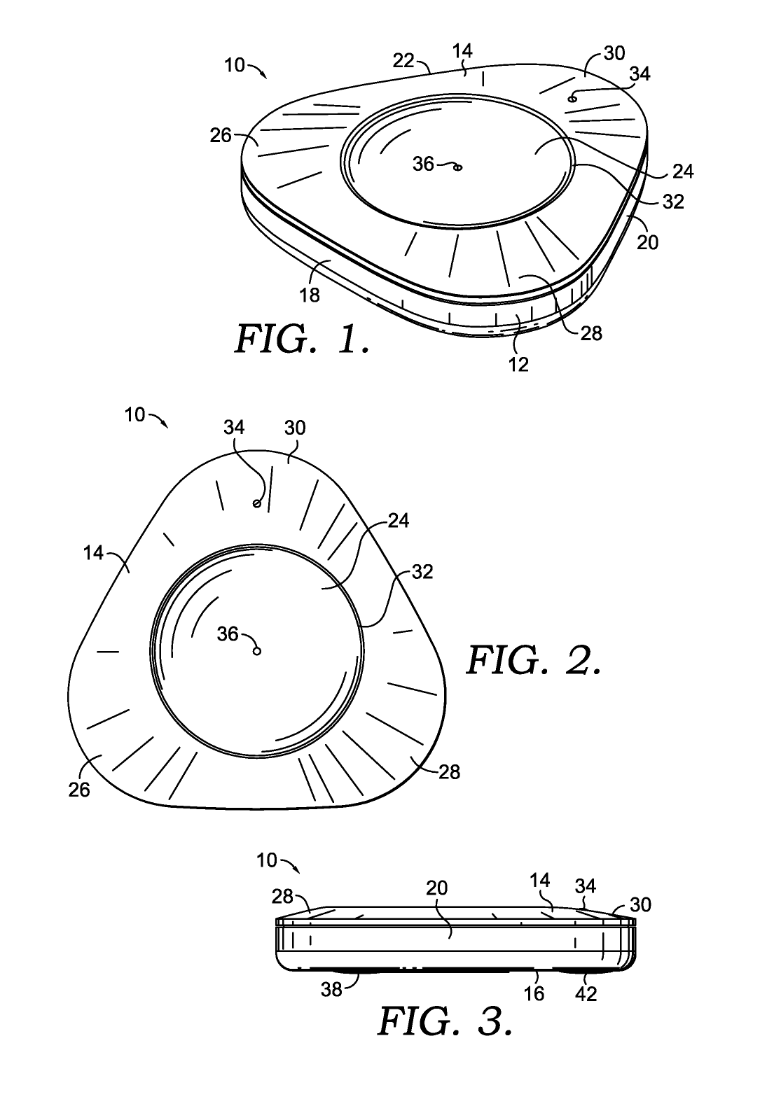

The top 14 of the input device 10 includes a trackpad 24 surrounded by three buttons 26, 28, 30. The trackpad 24 comprises a tactile sensor, such as a capacitive sensor, for receiving touch input from a user. The trackpad 24 may support multi-touch input. The trackpad 24 shown in the configuration of FIGS. 1 and 2 is substantially centered on the top 14. In particular, the trackpad 24 may either be perfectly centered on the top 14 or the trackpad 24 may not be perfectly centered but located slightly closer to one or more of the buttons than one or more of the other buttons. The trackpad 24 also has a circular shape that implies to the user that a circular motion may be provided within the trackpad 24 to provide a jog wheel-like input, for instance, to scroll up/down a list or page, adjust up/down the volume, rotate a selected design object, etc. The trackpad 24 in FIGS. 1 and 2 also has a concave shape, which allows a user to blindly feel where the user's finger(s) is/are located within the trackpad 24. A trackpad edge 32 is also provided that separates the trackpad 24 from the remainder of the top 14. The trackpad edge 32 provides a tactile surface, such as a chamfer or beveled edge, which allows the user to blindly identify when the user's finger has reached the trackpad edge 32. While the trackpad 24 in the configuration of FIGS. 1 and 2 is substantially centered with a circular and concave shape, it is contemplated that other configurations may include a trackpad that is not centered and/or has alternative shapes.

The input device 10 has a triangular design, and as such, the top 14 includes three corners. While the corners are rounded in the configuration of FIGS. 1-4, the corners may be sharp, squared-off, or have another formation in other configurations. Buttons 26, 28, 30 are located on the top 14 of the input device 10 at each of the corners. By placing the buttons 26, 28, 30 at the corners of the top 14, a user may quickly and blindly find the buttons 26, 28, 30 by feeling the input device 10 with their hand. This eliminates any need for the user to remove his/her eyes from a display screen to select any of the buttons 26, 28, 30.

Any of a variety of technologies may be employed to provide the buttons 26, 28, 30. In some configurations, the buttons 26, 28, 30 may each be provided using a tactile sensor, such as a capacitive sensor. In other configurations, each of the buttons 26, 28, 30 may be provided using a switch, such as a tact switch. In one embodiment, the top 14 comprises a unibody plate suspended above the enclosure 12 using a mechanism that provides some travel of the plate relative to the enclosure 12. For instance, the unibody plate may be provided with a 360-degree pivot. A tact switch or other switch is provided on the enclosure 12 under each corner of the suspended plate. As such, an input is provided via one of the buttons 26, 28, 30 when a user presses a corner of the plate down to engage the underlying switch. Additionally, the travel provided to the plate allows for multiple combinations of the buttons 26, 28, 30 to be selected. For instance, a user may simultaneously press any two or all three of the buttons 26, 28, 30.

A bump 34 is provided on a button 30. The bump 34 may comprise any size or shape and allows a user to blindly identify the button 30 as corresponding with a particular input. The other buttons 26, 28 do not include any similar bump in the configuration shown in FIGS. 1 and 2. Instead, the user may blindly identify the other buttons 26, 28 relative to the bump 30 (e.g., the button 26 to the left of the bump 30 and the button 28 to the right of the bump 30). In some other configurations, one or more bumps may be provided at either or both of the other buttons 26, 28. The bumps on any other button 26, 28 may include a different number of bumps, a different sized bump, and/or a different shaped bump to allow the user to blindly differentiate the buttons 26, 28, 30.

As can be seen in FIG. 3, the top 14 is configured to extend diagonally upward from the edge of each of the sides 18, 20, 22 to the trackpad edge 32 in a generally pyramidal shape. This design may further improve the feel of the input device under the user's hand and allow for the user to quickly and blindly find the trackpad 24 and buttons 26, 28, 30 using his/her fingers.

The input device 10 also includes an indicator light 36, which provides an indication of the status of the input device (e.g., on, off, standby, charging, paired, unpaired, etc.). The indicator light 36 may be an LED light or any other suitable light. In the configuration shown in FIGS. 1 and 2, the indicator light 36 is provided in the center of the trackpad 24. However, it is contemplated that in other configurations, the indicator light 36 may be provided at other locations on the input device 10.

The bottom 16 of the input device 10 is a generally planar surface that allows the input device 10 to sit on top of a surface, such as a desktop. Feet 38, 40, 42 are provided at the corners of the bottom 16. The feet 38, 40, 42 protrude from the bottom 16 and may be made of non-slip silicone rubber or other material that resists movement of the input device 10 relative to a surface on which it is placed. By providing the feet 38, 40, 42 at the corners of the bottom 16, the feet 38, 40, 42 are positioned underneath the buttons 26, 28, 30 and, as such, help stabilize the input device 10 when a user presses the buttons 26, 28, 30.

One or more magnets (not shown) may also be provided at the bottom 16 of the input device 10 (e.g., exposed externally or located within the enclosure 12). Such magnets allow the input device 10 to be maintained on a magnetic surface. For instance, the input device 10 may be placed on the back of a touchscreen device having a magnetic backside or cover. As such, the user may interact with the trackpad 24 and buttons 26, 28, 30 by simply reaching around the backside of the touchscreen device. This may be particular useful in mobile situations, such as while sitting on a couch or a bus.

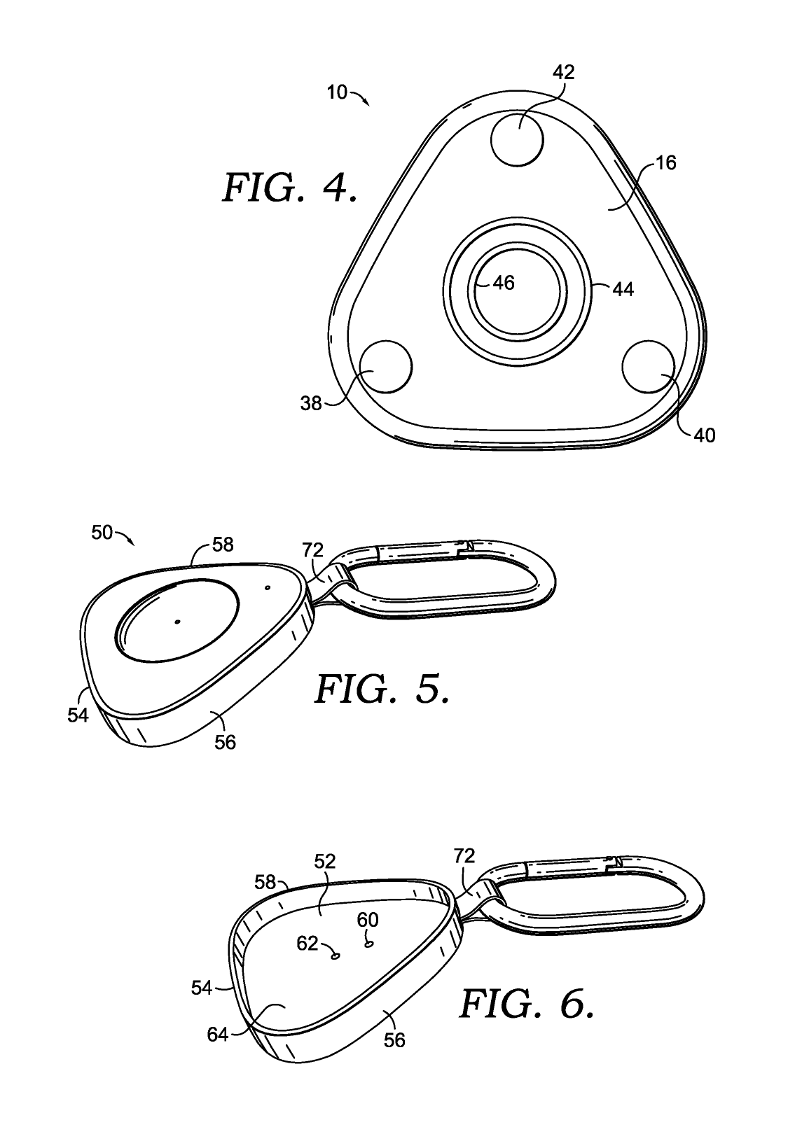

The input device 10 is powered using a rechargeable power source, such as rechargeable batteries. As such, the bottom 16 of the input device 10 includes a pair of charging contacts 44, 46 for charging the input device 10. It should be understood that other techniques for charging the input device 10 may be provided in alternative configurations (e.g., a micro USB charging port). As shown in FIG. 4, the charging contacts 44, 46 are circular and comprise a pair of concentric rings. This allows the input device 10 to be mated with a charging device in any configuration without requiring the user to know which of the charging contacts 44, 46 is positive and negative or requiring the user to align the charging contacts 44, 46 with the charging device.

In some embodiments, a charging case 50 such as that shown in FIGS. 5-8 may be used to charge the input device 10. The charging case 50 includes a bottom 52, sides 54, 56, 58 and has a triangular shape that matches the triangular shape of the input device 10. A pair of charging contacts 60, 62 are positioned on an inside surface 64 of the bottom 52. Because the charging contacts 44, 46 on the input device 10 are circular, each of the charging contacts 44, 46 on the input device 10 will engage the proper one of the charging contacts 60, 62 in the charging case 50 regardless of the orientation with which the input device 10 is placed within the charging case 50.

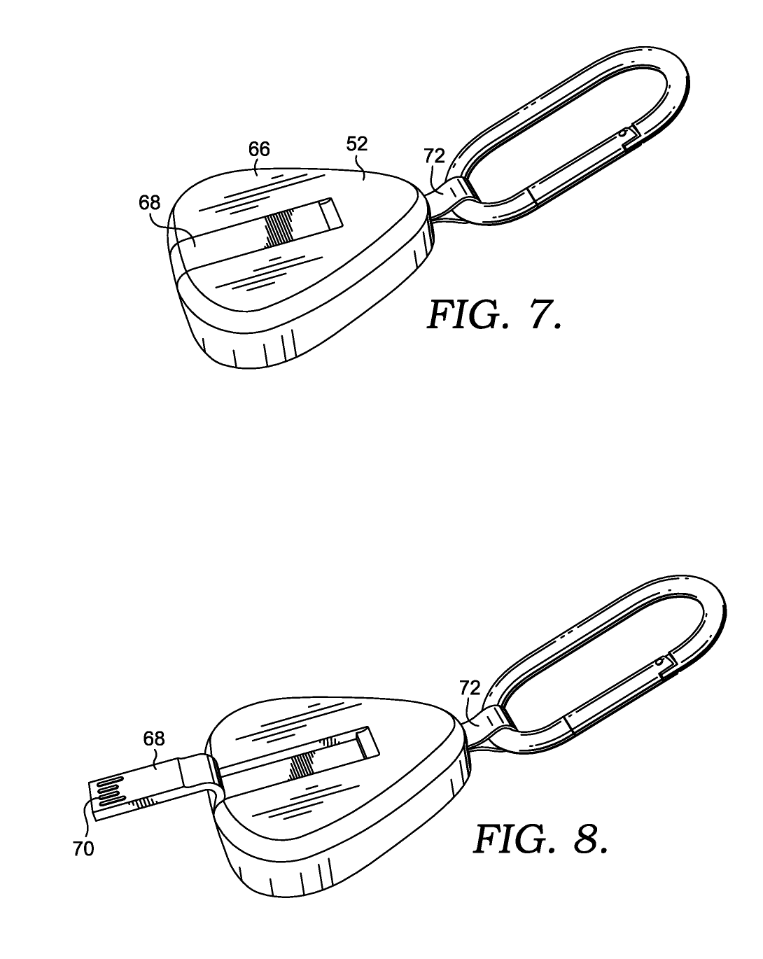

The outer surface 66 of the bottom 52 of the charging case 50 includes a recharging arm 68 that is hingeably attached to the bottom 52 at one end such that the recharging arm 68 may be retracted from the bottom 52 (as shown in FIG. 8). A USB plug 70 is disposed on the free end of the recharging arm 68. The USB plug 70 is in electrical communication with the charging contacts 60, 62. As such, the input device 10 may be recharged by placing the input device 10 within the charging case 50 and inserting the USB plug 70 on the recharging arm 68 in a USB port (e.g., on a computer or a charger having a USB port).

As shown in FIGS. 5-8, the charging case 50 includes a loop 72 that allows the charging case to be attached to bag, belt loop, or other location via, for example, a carabineer or other hooking mechanism to facilitate traveling with the input device 10 within the charging case 50.

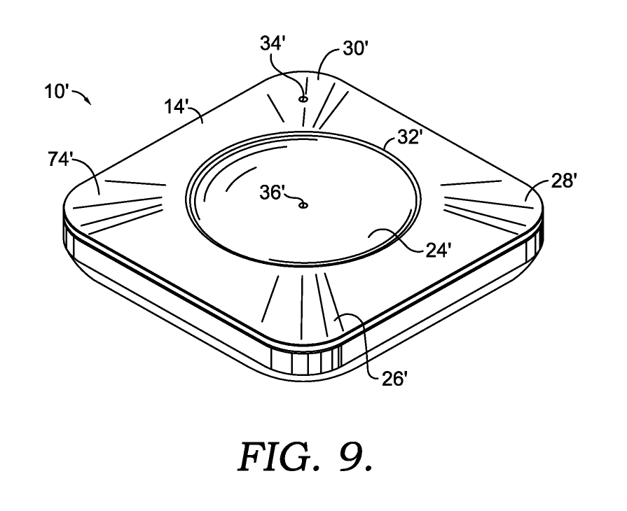

While the input device 10 shown in FIGS. 1-4 has a triangular shape, input devices in accordance with other configurations may have other polygonal shapes, in which a button is provided at each corner of the top surface, thereby providing more than three buttons in such alternative configurations. By way of example to illustrate, FIG. 9 illustrates an input device 10′ that has a rectangular shape. As such, the top 14′ of the input device 10′ includes four buttons 26′, 28′, 30′, 74′. A circular trackpad 24′ is provided substantially centered on the top 14′ of the input device 10′ between the buttons 26′, 28′, 30′, 74′. Other features, such as the trackpad edge 32′, bump 34′, and indicator light 36′, may be similar to those discussed above with reference to FIGS. 1 and 2.

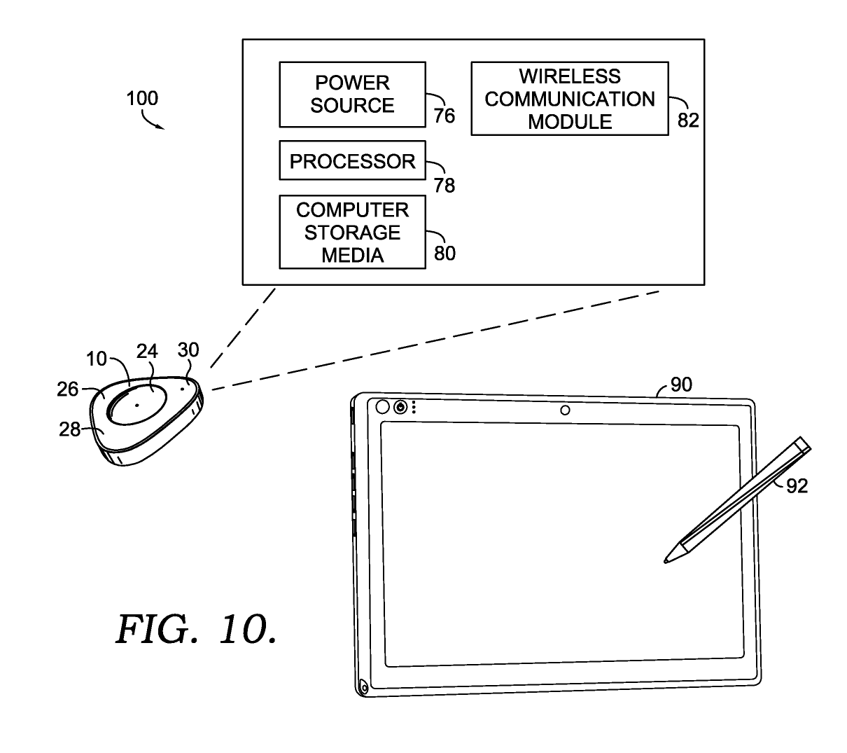

FIG. 10 illustrates an exemplary system 100 that includes the input device 10 operating in conjunction with a touchscreen device 90 and a digital pen 92. The input device 10 includes a number of internal electronic components that facilitate pairing the input device 10 with the touchscreen device 90 and/or the digital pen 92 and communicating inputs received via the trackpad 24 and buttons 26, 28, 30 to the paired touchscreen device 90 and/or digital pen 92. As shown in FIG. 10, the internal electronic components of the input device 10 include, among other components not shown, a power source 76, processor 78, computer storage media 80, and wireless communication device 82 (e.g., Bluetooth transceiver).

Software on the touchscreen device 90 may be configured with application programming interfaces (APIs) that allow the software to receive input signals from the input device 10 and convert those signals to specific inputs to an application running on the touchscreen device 90. For instance, the APIs may map inputs from the internal device to inputs for the target application on the touchscreen device 90. In some instances, the trackpad and button inputs may be mapped to default application inputs. For instance, each button may be mapped to a particular keyboard key (e.g., a first button may be mapped to the “ctrl” key, a second button may be mapped to the “alt” key, and a third button may be mapped to the “shift” key). The default mappings may be system-wide defaults (i.e., apply to all applications on the touchscreen device 90) or may be application-specific defaults. In some instances, the mappings may be user-configurable to allow the user to set the inputs provided to applications based on inputs received via the input device 10. The user-configurable mappings may be system-wide or application-specific. Further, the inputs from the input device 10 may be paired with inputs from the digital pen 92 provided to the touchscreen device 90. For instance, a trackpad 24 may be used to adjust the width of a brush stroke from the digital pen 92 within a drawing application on the touchscreen device 90 by the user moving a finger clockwise or counterclockwise within the trackpad 24.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

While specific elements and/or steps are discussed in connection to one another, it is understood that any element and/or steps provided herein is contemplated as being combinable with any other elements and/or steps regardless of explicit provision of the same while still being within the scope provided herein. Since many possible embodiments may be made of the disclosure without departing from the scope thereof, it is to be understood that all matter herein set forth or shown in the accompanying drawings is to be interpreted as illustrative and not in a limiting sense.

The invention claimed is:

1. An input device comprising:
an enclosure having a top, a bottom, and at least three sides;
the enclosure housing one or more electronic components; and
the top having a polygon shape including at least three corners with a trackpad substantially centered on the top and a button located at each of the at least three corners.

2. The input device of claim 1, wherein the trackpad comprises a capacitive sensor.

3. The input device of claim 1, wherein the trackpad comprises a circular shape.

4. The input device of claim 3, wherein the trackpad is concave.

5. The input device of claim 1, wherein a tactile edge is provided separating the trackpad from a remainder of the top.

6. The input device of claim 1, wherein each button comprises a capacitive sensor.

7. The input device of claim 1, wherein the top comprises a unibody plate that is pivotably attached to a remainder of the enclosure, and wherein each button is provided by a tact switch located under each corner of the unibody plate.

8. The input device of claim 1, further comprising a bump provided on a first button.

9. The input device of claim 1, wherein the bottom comprises a foot located at each of the corners opposing each of the buttons.

10. The input device of claim 1, wherein the bottom comprises a pair of charging contacts, the pair of charging contacts comprising a pair of concentric rings.

11. The input device of claim 1, wherein the top extends diagonally upward from an edge between the top and each of the at least three sides to the trackpad in a pyramidal shape.

12. The input device of claim 1, further comprising an indicator light located at a center of the trackpad.

13. The input device of claim 1, further comprising at least one magnet disposed at the bottom of the input device.

14. An input device comprising:
an enclosure having three sides, a top, and a bottom, the top and bottom each having a triangular shape with three corners;
a trackpad substantially centered on the top, the trackpad having a circular shape and being concave with a tactile edge separating the trackpad from a remainder of the top;
three buttons surrounding the trackpad at the three corners of the top; and
three feet positioned at the three corners of the bottom opposing the three buttons on the top.

15. The input device of claim 14, wherein the trackpad comprises a capacitive sensor.

16. The input device of claim 14, wherein each button comprises a capacitive sensor.

17. The input device of claim 14, wherein the top comprises a unibody plate that is pivotably attached to a remainder of the enclosure, and wherein each button is provided by a tact switch located under each corner of the unibody plate.

18. The input device of claim 14, wherein the bottom comprises a pair of charging contacts, the pair of charging contacts comprising a pair of concentric rings.

19. The input device of claim 14, wherein the top extends diagonally upward from an edge between the top and each of the three sides to the trackpad in a pyramidal shape.

20. An input device comprising
a housing having a top, a bottom, and at least three sides, the top and bottom each having a polygonal shape with at least three corners;
a circular trackpad centered on the top; and
at least three buttons positioned on the top, wherein each button is located at one of the at least three corners.
